(19) United States
(12) Patent Application Publication
(10) Pub. No.: US 2021/0390563 A1
(43) Pub. Date: Dec. 16, 2021

(54) METHOD AND SYSTEM FOR IDENTIFYING AN OPPORTUNITY

(71) Applicant: Aptivio Inc, New York, NY (US)

(72) Inventors: Guy Adrien Mounier, New York, NY (US); Christopher Leif Even, New York, NY (US)

(21) Appl. No.: 16/899,309

(22) Filed: Jun. 11, 2020

(51) Int. Cl. G06Q 30/02; G06F 40/20; G06F 17/18

(52) U.S. Cl. CPC G06Q 30/0201; G06F 17/18; G06F 40/20

(57) ABSTRACT

A computer-implemented sales assistance method that monitors electronic activity and searches for events and generates a collection of signals from said events is presented. The method receives user criteria via a user interface that include the selection of keywords and signals, scores the signals using the criteria, and extracts one or more opportunities from the signals and determines actions that users should follow to meet the opportunities. The method is capable of providing a timeline for an opportunity, a window of opportunity, an opportunity map as well as a list of potential buyers associated with an opportunity, together with their inferred contact information and email addresses. The method is particularly useful for sales and business development, but it has utility in other scenarios as well.

### RELATED FIELD

This invention generally relates to identification of an opportunity from digital activities, and more specifically to the field of mining digital processes that underpin client interactions with a business.

### BACKGROUND

The Internet has revolutionized the way in which customers/clients approach the adoption of a new enterprise solution. Customers/clients may search the Internet for companies providing a given solution, and this search information in turn provides valuable clues to a sales organization that provides that given solution. For example, if Company A performs a lot of searches with words such as “copyright infringement,” “intellectual property law firm,” and “copyright attorneys,” those searches provide a clue to law firms that handle copyright cases that there might be potential business to be won from Company A.

A motivated customer/client may also post a potential job offer in a related job category when a certain stage in the budgeting process has been reached, so they may readily get on board with a new technology with a new hire. In this way, when the purchase of the new technology is finalized, they may install and use the product without costly or otherwise disabling delays. Typically, such hiring information is publicly available and is advertised, so that many candidates may be reached. Therefore, this would be another type of information that provides clues to a proactive sales organization.

A method and system that provides sales organizations with sales leads by monitoring the information that is output by potential customers/clients is desired.

### SUMMARY

Embodiments of the invention pertain to a computer-implemented method of identifying an opportunity that monitors electronic activity and searches for events, receives user criteria via a user interface, ranks the events using the user criteria, generates signals from the events, and extracts one or more opportunities from the signals and determines an action that is likely to turn the one or more opportunities into sales.

### BRIEF DESCRIPTION OF THE DRAWINGS

FIG. 1A is a pictorial illustration of a timeline, and early, active, definite and missed opportunities.

FIG. 1B is an example illustration of a User Interface showing top signals.

FIG. 2 is an example illustration of User Interface showing a six-week window of opportunity.

FIG. 3 is a pictorial illustration of an opportunity map showing cities where certain opportunities are present.

FIG. 4 is a flow chart describing a signal processing engine.

FIG. 5 is a depiction of signals.

FIG. 6 is a flow chart describing the process of data crawling for news, social media and job postings.

FIG. 7 is a flow chart describing signal scoring for news, social media and job postings.

FIG. 8 is a flow chart describing the process of data crawling for client searches.

FIG. 9 is a flow chart describing the process of signal scoring for client search surges.

FIG. 10 is a flow chart describing the computation of opportunity probabilities and risk probabilities.

FIG. 11 is a flow chart describing the usage of machine learning.

FIG. 12 is a flow chart describing growth signals.

FIG. 13 is an example illustration of a User Interface showing the identification of potential buyers.

FIG. 14 depicts a block diagram showing how the different parts of the disclosure are interrelated, in accordance with an embodiment of the inventive concept.

### DETAILED DESCRIPTION

The disclosure pertains to an improved method and system for digital sales lead mining. The present invention is particularly useful for sales and business development, but it has utility in other scenarios as well.

Generally, as customers interact with a business, events (e.g., searches, job postings) happen that can provide useful insight into what is going on with the customers. When those events are logged and thoughtfully processed, it is possible to automatically extract information that can be acted upon. Enterprises that fail to automate such processes over time are likely to fall behind their competition as they will spend additional energy and time obtaining sales lead information that could have been already available to them, yet that they have missed due to their antiquated infrastructure. Meanwhile, their more agile competition may have already acted and capitalized on an opportunity.

For instance, when customers research a solution or take steps toward staffing their organization for a particular skill, such information is generally publicly available. A well-informed sales organization may access this information and infer that a customer is ready to purchase a certain product or solution.

A motivated customer may interact with a certain supplier but may also interact with competitors of that supplier, and the nature of such interactions can be telling of the stage of the contemplated transaction. Such patterns of interaction might even reveal that an opportunity was missed as the customer is too far along in their negotiation and purchasing process with a competitor.

Certain external factors may also signal that a buying intent is imminent. Certain court cases, such as a copyright infringement case, for instance, may prompt various actions inside companies that are potentially affected by such decisions, and these actions may feature economic decisions involving the purchasing of specialized products, services or solutions.

By way of another example, a company may announce publicly that they are settling a lawsuit. This event may signal to this company, certain competitors, or possibly an entire business sector, that they will want to invest in a solution designed to avoid similar complaints or legal problems.

The location of certain offices of employers and relevant actors may also be significant. For example, if multiple Internet search queries for a certain topic are originating from the same corporate office, this raises the probability that a concerted effort to research a subject and possibly acquire a product is being entertained. This would also allow to predict which Business Unit of a certain company would be interested in a product and possible names and titles of the people involved in such queries. Such names and titles can be inferred by searching websites and relevant databases.

A number of systems and methods have been described for some type of sales process mining. For example, U.S. Pat. No. 10,509,786 to Oley Rogynskyy et. al. attempts to automatically match records based on entity relationships. This system by Rogynskyy et. al. focuses on constructing a node graph based on electronic activity. It lacks the concept of timeline and window of opportunity as in the present invention.

U.S. Pat. No. 10,210,587 to Neal Goldman describes a system that nurtures relationships by providing users news and other events that happen to people they are connected to. Goldman's system lacks the concept of signals that typically characterize the nature of the business relationship, and also fails to capture other data sources such as client searches and job postings.

U.S. Pat. No. 10,430,239 to Lei Tang et al. describes a system that predicts the possible completion of a first set of sales tasks based on the calibrated completion of a past set of sales tasks. This system fails at understanding external client activity and therefore the risks associated with an opportunity (e.g., if the client starts interacting with a competitor). It also lacks the understanding of the buying influence of the client, which is a critical weight in the importance of the sales tasks at hand. Many salespeople do busy work but interact with low level clients.

U.S. Patent Application Publication No. 2019/0378149 to Hua Gao et al. describes a system that generates sales leads by comparing target clients similarities in fitness, engagement, and buying intent. This method, however, lacks explanation of the specific signals that makes a lead relevant to a salesperson, ultimately causing trust issues with the result and preventing a successful engagement on the basis of specific trigger events that one can state in an introduction email.

U.S. Pat. No. 10,475,056 to Amanda Kahlow describes a system that predicts sales readiness based on a timeline of events from various website visitors data sources, and identifies spikes of events that indicate buying interest. The prediction is primarily driven from internet search and website activities, and does not consider internal sales activity, company profile fitness data, and buyer engagement data. It does not determine the probability of an opportunity to close, but provides a weighted average of events based on data source type and event freshness. Moreover, it does not provide a buyer map and relevant buyers to engage, nor does it suggest topics of interest.

A white paper titled “Workflow Mining: Discovering Process Models from Event Logs” was published in IEEE Transactions on Knowledge and Data Engineering—Volume 16, Issue 9, and numbered DOI: 10.1109/TKDE.2004.47. The paper presents a new algorithm to extract a process model from a “workflow log” containing information about the workflow process, as it is actually being executed, and represents it in terms of a Petri net. This white paper lacks domain specificity, with both the data and concepts related to the sales process and opportunity signal mining, namely the Buyer Timeline and Buyer Stage. It also lacks the signal mining required to transform raw and noisy data into growth signals useful to salespeople. Lastly, it lacks the relevant buyer map and buyer engagement information, which is critical to not just discover, but also execute, a sales process.

The system of the disclosure is capable of providing a timeline for an opportunity, a window of opportunity, an opportunity map, a series of signals as well as a list of potential buyers associated with an opportunity, together with their inferred contact information and email addresses.

General Layout

As used herein, a “user” or a subscriber is a person or entity who has permission to use the sales process mining system to obtain information about business opportunities, or a person or entity looking for a sales lead. A “client” or a “target” is a person or entity whose business is of interest to the user, and may be public or private person or entity related to or supporting the user's industry sector. “Client searches” are searches performed by clients or targets.

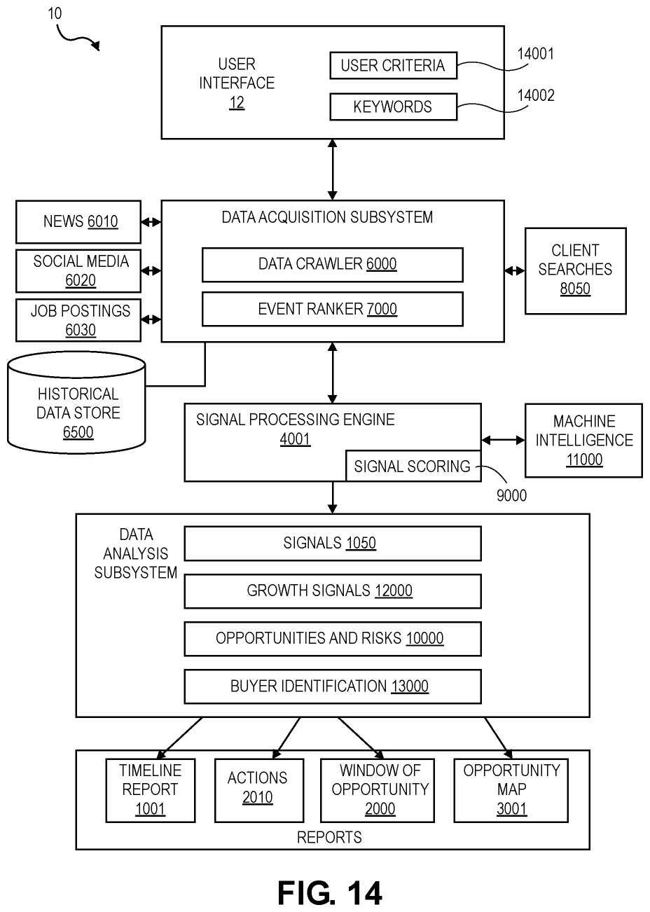

FIG. 14 is a block diagram of the general layout of the sales process mining system 10 in accordance with an embodiment of the disclosure. The sales process mining system 10 generally monitors electronic activity and searches for relevant “events,” then generates signals indicating relevant events. The monitoring is done by data crawler 6000 that crawls predefined set of websites including news, social media, and job postings, as well as client searches, based mostly on text representations. The data acquired by crawling are then processed and analyzed, optionally with the help of machine intelligence, to yield signals, growth signals, opportunities and risk probabilities, and buyer identification. These metrics guide user/clients with their decision on when and where to invest their sales/marketing efforts.

As shown, the system 10 receives user criteria 14001, which may include keywords 14002, from a user interface. Data crawler 6000 and event ranker 7000 access information received via the user interface 12, such as the user criteria 14001. “User criteria” may include a target market and products/services that are sold by the user/client. “Target market,” in turn, includes company sector and size, and may be as specific as names of entities. The data crawler 6000 crawls through news 6010, social media 6020, and job postings 6030. In addition, the data crawler 6000 also crawls client searches 8050. Events are selected and ranked or weighted by an event ranker 7000, based on the centrality and importance of an entity (e.g., an entity in target market) in the article or posting. The output of the event ranker 7000 is fed to the signal processing engine 4001.

The signal processing engine 4001 generates signals 1050 and growth signals 12000. Signals 1050 and growth signals 12000 are, in turn, used for opportunities and risk probability processing 10000 and buyer identification 13000 with the help of machine intelligence 11000. As a result of these operations, one or more reports are generated, such as a timeline report 1001, a window of opportunity 2000, actions 2010, and an opportunity map 3001.

Each part of the sales process mining system 10 will now be described in more detail.

Signals

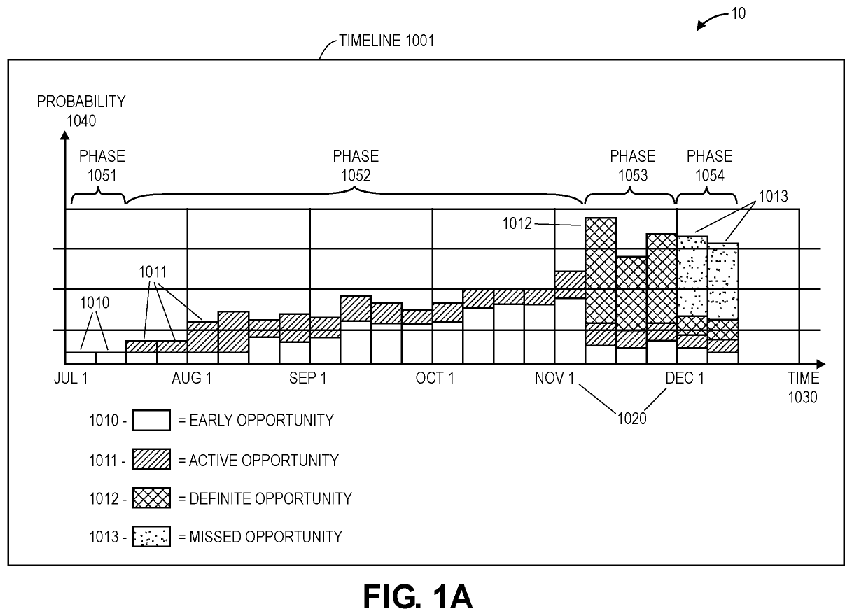

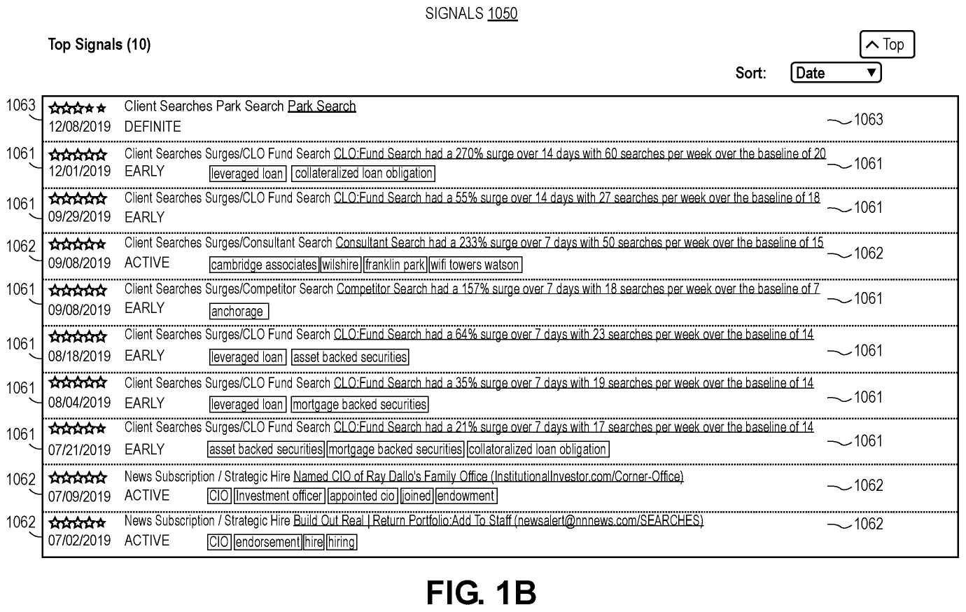

A “signal” indicates that there may be an activity or opportunity of interest. A signal may be based on an event (e.g., a client search or a job posting) or a plurality of events (e.g., a surge in client searches for short-term loans). The events that are extracted from various data sources are ranked and converted into signals 1050. FIG. 1B depicts signals 1050, which correspond to particular events that were identified as being relevant and ranked based on user criteria, using a process which is disclosed herein.

An Early Signal 1061 may correspond to an Internet search for a specific term in the field such as “leveraged loan” for a firm providing financial services of the particular kind. In the example that is shown in FIG. 1B, six events are indicted to be early signals 1061.

An Active Signal 1062 may correspond to an announcement of a strategic hire in a specific job that is required in the art. An example for a firm providing financial services would be “investment officer”, or the acronym “CIO”. An Active Signal 1062 may also correspond to the search for specialized consultants in the field who may assist in the selection of products, risk assessment, as well as implementation. As a prospect looks for such consultants, they may search the Internet for the names of firms that are well known in supplying such consultants and typical search terms might be (in lowercase) “cambridge associates” or “franklin park”, or the like. In the example of FIG. 1B, three events are categorized as active signals 1062.

A Definite Signal 1063 is generated based on an event indicating a search for a specific brand of solution or company name able to supply such solution. Exemplary search terms might be (in lowercase) “napier fund” or “joseph lane”, or the like. In the example of FIG. 1B, one event is categorized as a definite signal 1063.

FIG. 5 depicts examples of signals and Opportunities, wherein opportunities are determined based on number and type of signals. Generally, Opportunities (further illustrated in FIG. 1A) are less specific than the signals that are shown in FIG. 1B. Signal 5001 consists of an anonymous website visit on October 6^{th}. “Anonymous website visit,” as used herein, means someone visited the client's website anonymously, such that the user does not know the identity of the person or the entity affiliated with the search.

Signal 5002 consists of a competitor website visit made by a client or target company on October 6^{th}. The client's interest in a competitor may signal a lead for the user. Signal 5003 consists of a job posting for “digital content specialist” by the target company on August 7^{th}. Signal 5004 consists of a surge in searches for “copyright violation” on June 2^{nd}. Signal 5005 consists of a United States court case filing for “copyright infringement” on April 18th. Each of signals 5001, 5002, 5003, 5004, and 5005 may be categorized into early signal, active signal, or definite signal. When combined, these signals may generate an Active Opportunity 1011 or maybe even a Definite Opportunity 1012 because the chronology of the individual signals indicate that the client or target has some type of copyright issue and needs services to deal with the issue. The fact that the client visited a competitor website in signal 5002 indicates that the client is actively searching for professionals to hire, and that perhaps the anonymous website visit of signal 5001 was made by the same client.

### Timeline Report

Referring to FIG. 1A, a timeline report 1001 is presented with time 1030 on the horizontal axis and a probability trend 1040 on the vertical axis. The timeline report 1001 generally divides up the probability trend into different types, each type being characterized according to opportunity level. In the example embodiment of FIG. 1A, there are four types: an early opportunity 1010, an active opportunity 1011, a definite opportunity 1012, and a missed opportunity 1013. Specific dates 1020 such as November 1^{st} or December 1^{st} are also represented as points of reference. The timeline report 1001 of FIG. 1A is specific to a target or client.

An early opportunity 1010 is typically labelled as such when one observes any or all of the following elements:
1. A surge in client searches of a keyword or specialized term of the art, such as “leverage loan” or “asset-based securities” or “mortgage backed securities” or “loan obligation”
   or any such term that a potential client would we expected to look for on a search engine of the Internet.
2. A visit or multiple visits on the user's web site;
3. Searches for competitor solutions.

An active opportunity 1011 is typically labelled as such when a strategic hire is being announced or when there is a surge in client searches on particular consultants who are specialists in the field of interest. It is thought that the consultants will be needed to select a particular solution, or possibly assess its feasibility, or possibly assist in implementing such solution. A definite opportunity 1012 is labelled as such when there is evidence that a customer is looking for a specific brand or company name.

A missed opportunity 1013 is labelled as such when information is uncovered establishing that a customer has decided upon a competing product. This may correspond to a public statement such as a press release on either the customer or competitor side, or both sides. Other information may also allow to infer a similar conclusion. Efforts to win the opportunity are pointless at this stage. A sales organization may then choose to acknowledge that sale and monitor the progress of the installation.

Referring back to FIG. 1A, the timeline 1001 also typically represents certain phases 1051, 1052, 1053, 1054.

In Phase 1051, there is a preponderance of Early Opportunity 1010 being observed and collected by the system of the present disclosure. Referring to the example in FIG. 1A, Phase 1051 occurs before August 1^{st}. In Phase 1052 there is gradual growth in the number of Active Signals being observed and collected. Referring to the example in FIG. 1A, Phase 1052 occurs between August 1^{st} and November 1^{st}.

In Phase 1053 a Definite Opportunity 1012 is detected based on type and number of signals. Referring to the example in FIG. 1A, Phase 1053 occurs during November. In Phase 1054 a Missed Opportunity 1013 is detected based on types and number of signals. Referring to the example in FIG. 1A, Phase 1054 occurs after December 1^{st}.

Phases are useful for the computation of windows of opportunity.

### Windows of Opportunity

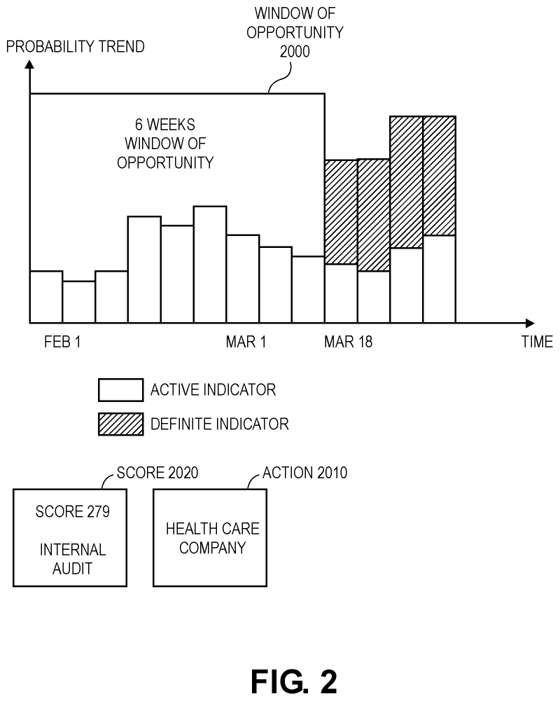

Referring to FIG. 2, a Window of Opportunity 2000 is illustrated. By analyzing the timeline 1001 of FIG. 1A, one may observe that certain phases, such as 1051, and 1052, have typically longer durations and other phases such as 1053, and 1054 have typically shorter durations. This means that there is typically a short span of time for a phase 1053 during which a definite opportunity 1012 is available.

In the particular example illustrated in FIG. 2 the corresponding phase 1053 indicating an active opportunity 1012 lasts about six weeks and thus represents a six-week window of opportunity 2000. This will be the best time for the client to execute on a strategy to win a given prospect. This means that the seller's offer should be fully presented and available to relevant buyers during the window of opportunity 2000.

Once the window of opportunity 2000 closes, there will be little time left to influence a decision and it likely will be too late to start a campaign. Therefore, action must be taken, and a strategy executed while the window of opportunity 2000 remains open. To assist the client in deploying such strategy, and as illustrated in FIG. 2, the present invention may list certain Actions 2010 that the client may perform to accomplish their goal. The present invention may also assign a Score 2020 pertaining to the validity of certain Actions 2010. An example of such Action 2010 is to contact a certain buyer at a certain company within a prescribed window of time. A number of such Actions 2010 may be presented by the system together with a score vouching for the confidence behind such action. As shown in the example of FIG. 2, an Action 2010 indicates target type, such as industry sector (e.g., Healthcare company) and a signal score 2020 (e.g., 274). In one embodiment, a higher signal score indicates a stronger reason to pursue this opportunity. More information about signal scoring is provided below.

### Opportunity Map

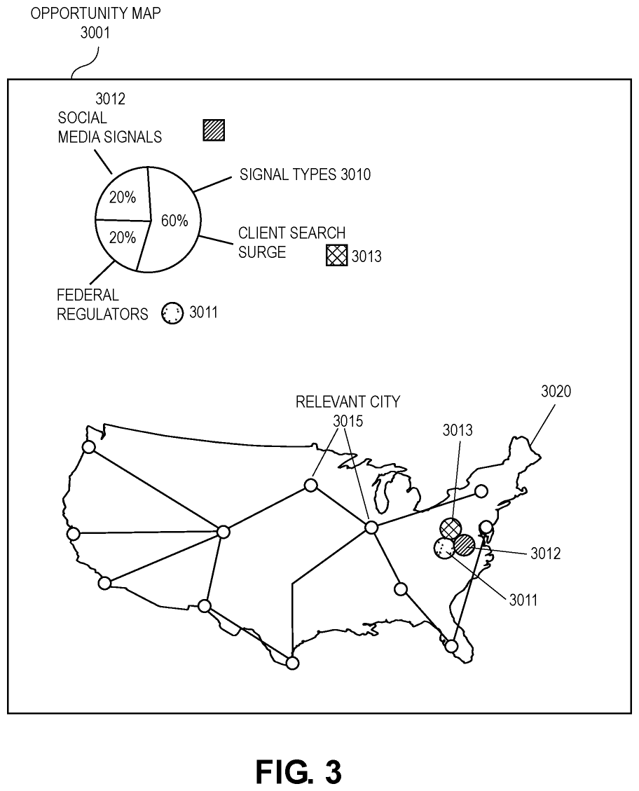

In another aspect of the present invention and referring to FIG. 3, an Opportunity Map 3001 is introduced. As shown in FIG. 3, several signals are represented inside a signal types pie chart 3010. These include signals related to federal regulators 3011, social media signals 3012 and client search surges 3013 and indicate sources of relevant signals (e.g., announcements, publications, searches). In the particular example illustrated in FIG. 3, federal regulators 3011 represent 20% of the area contained in Chart 3010, while social media signals 3012 represent another 20% and client search surges 3013 represent the rest, 60%.

A schematic map 3020 of the geography of relevance is also drawn as part of FIG. 3. It also displays certain relevant cities 3015 for the client. The abovementioned signals 3011, 3012, and 3013 are also associated with a geo-location as is depicted later in the present specification, and can thus be displayed on the map 3020 with a surface area corresponding to their percentages of the chart 3010, and therefore, a measure of their importance. Relevant cities 3015 are also shown, “relevant” meaning that those cities may be of interest to the particular user to whom the map 3020 is presented, based on user criteria. Different users would be shown different relevant cities 3015.

A location that is associated with a signal may be the location where a social media posting or client search originated. In the example map 3020 that is depicted in FIG. 3, the federal regulators 3011, the social media 3012, and client search surges 3013 are all clustered around one area. The cluster of searches provides clues to the user that there might be an event of interest happening in that area.

The opportunity map 3001 combines the chart 3010 with a geographical map 3020 to portray a picture of the cities or geographies associated with the signals and their relative importance. A client using the opportunity map 3001 may thus infer which corporate offices are transmitting such signals and the system 10 may also help in suggesting which corporate officers or employees may be associated with such signals, as will be explained below.

### Signal Processing Engine

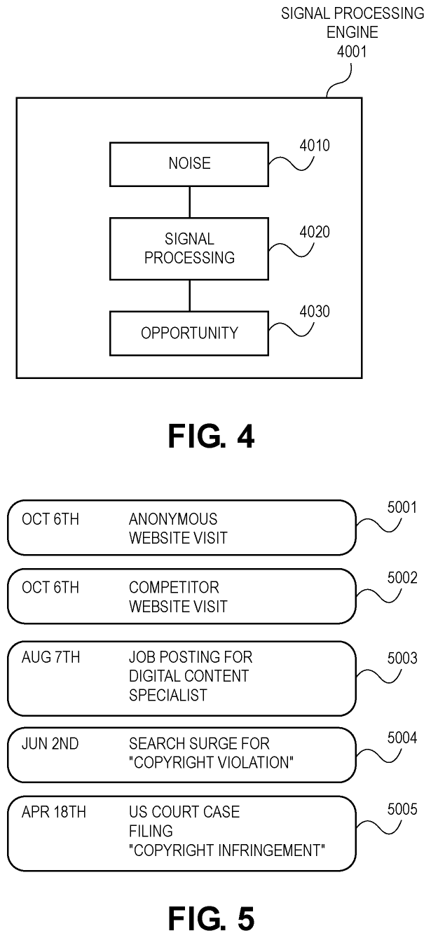

In another aspect of the system, a Signal Processing Engine 4001 is introduced. Referring to FIG. 4. The reports described above are based on the output of the Signal Processing Engine 4001, as shown in FIG. 14. The Signal Processing Engine 4001 comprises three main stages: Noise 4010, Signal Processing 4020, and Opportunity 4030.

Noise 4010 refers to a very high number, several billions, of economic data points that surface on a daily basis. These include any or all of the following:

Social media rumors

Breaking news

Client searches

Cyber web

Cloud usage

Interest surges

Programmatic advertising

Job postings

Job seeking behavior

Product shipments

Calls and emails

Company and people web profiles

Specialized industry websites

This is not an exhaustive list, and other economic data may be included. Furthermore, combinations with fewer than all the above economic data points may be used as well.

Signal Processing 4020 refers to a small relative number, on the order of one for every ten thousand, of events that are actionable for a particular client. These include:

Active hiring

Key sponsor leaving

Settlement reached

Surge in employee interest

Lack of executive team coverage

Client interaction with a competitor

Industry-related trigger event.

This is not an exhaustive list, and other events may be included. Furthermore, combinations with fewer than all the above events may be used as well.

An Opportunity 4030 may surface from assessing the impact of each new signal. When grouping signals by product and by company it becomes possible to identify that certain signals represent potential opportunities. For instance, for a client involved in financial services the signals that may indicate an opportunity could include:

News: Announcement of Material Weakness

Searches: Headquarters searching legal websites

Visits: Headquarters visited client website 4 times

Jobs: Hiring new CFO

Buyers: Contacts found in LinkedIn to connect with

In order to provide a score for the Opportunity 4030, the following criteria may be used:

risk sensing,

buying intent,

expertise required,

relationship capital.

This is not an exhaustive list, and other criteria may be included. Furthermore, combinations with fewer than all the above criteria may be used as well.

### Data Crawling for News, Social Media, and Job Postings

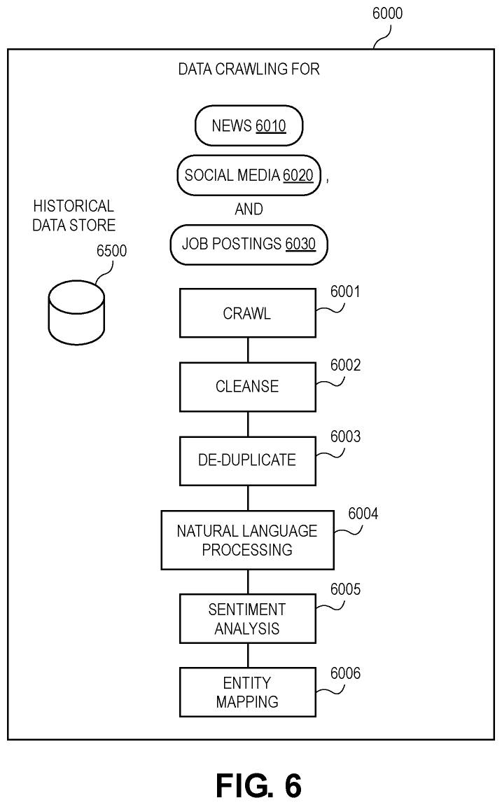

In another aspect of the system, in order to process and extract such signals from the available data sources, the following methods are being used. When the data sources consist of news, social media and job postings, and referring to FIG. 6, the method operates as follows.

Referring to FIG. 6, the signal extraction process 6000 of Data Crawling for News, Social Media and Job Postings is depicted. A first step in signal extraction 6000 is Crawl 6001. Crawl 6001 consists of continuously retrieving News 6010, Social Media 6020 and Job Postings 6030 from a multiplicity of data providers. Such news 6010, media 6020 and postings 6030 pertain to more than one million companies globally. In the present invention a single historical data store 6500 is created to draw signals from. This is a shared resource that is used for all clients. The news 6010, media 6020 and postings 6030 are filtered using keywords.

As illustrated in FIG. 6, a second step in signal extraction process 6000 is Cleanse 6002. This step removes irrelevant text, tags, and the like that do not carry information. A third step in signal extraction process 6000 is named De-duplicate 6003. This step searches a historical data store 6500 for duplicates, marks those duplicates, and removes those. A fourth step in the signal extraction process 6000 is named Natural Language Processing 6004. Known techniques in natural language processing are used to extract organization names, people names, locations, etc. from the data sources. A fifth step in signal extraction process 6000 is named Sentiment Analysis 6005. This step uses known techniques to categorize opinions in the pieces of text forming the historical data store 6500. In this step the system 10 determines whether the text is positive, negative or neutral toward a topic affecting a particular client.

A sixth and final step in signal extraction process 6000 is Entity Mapping 6006. In this step, the centrality and importance of an entity in a particular article or post is ranked. The particular industry and revenue level for each organization is also mapped.

### Signal Scoring for News, Social Media, and Job Postings

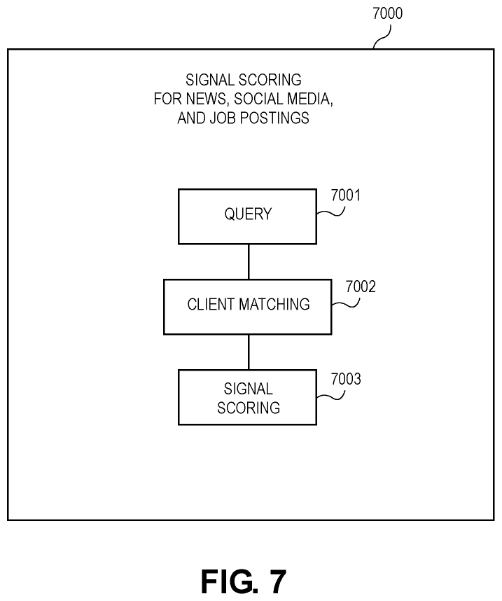

In another aspect of the disclosure, and referring to FIG. 7, a signal scoring process 9000 for News, Social Media and Job Postings is depicted. The signal scoring process 9000 may follow the signal extraction process 6000, although this is not a limitation of the disclosure. Referring to FIG. 7, the signal scoring process 9000 for news, social media and job postings consists of three steps that extract a signal from noise and provide scoring.

In a Query Step 7001, elements defining a signal such as keywords, website rank, and other filters are used to query the historical data store 6500 to find and create new signals. In the Query Step 7001, a base score (which is initially assigned by the sales process mining system 10) is also introduced and is associated with a time window of relevance. In the Client Matching Step 7002, signals that have entities matching clients, their competitors, their customers, and their potential customers are tagged.

In the Signal Scoring Step 7003, signals are geo-coded and associated with a relevant city 3015 using known geo-coding methods. This geo-coding allows a filtering step based on relevant geography. A final score is applied using the following elements, including but not limited to:

Configured Factors:
Signal Type
Stage
Impact

Calculated Factors:
Sentiment
Location
Activity Volume
Time-based Surges
Keyword Relevancy
Time Decay (Optional)

Dynamic Factors (Machine Learning Model created to generate weighting score)

Outcome-based User Feedback: Tagging Signals with Won or Rejected Deals

Quality Control-based User Feedback: QA Engineers rejecting a signal

The Signal Score is then Calculated:

Signal Score=Normalized (Signal Type)+Normalized (Sentiment)+Normalized (Activity Volume)+Normalized (Time-based Surges)+Normalized (Keyword Relevancy)+Normalized (Time Decay)×Weighted Factors (Outcome-based User Feedback+Quality-Control-based User Feedback)

### Data Crawling for Client Searches

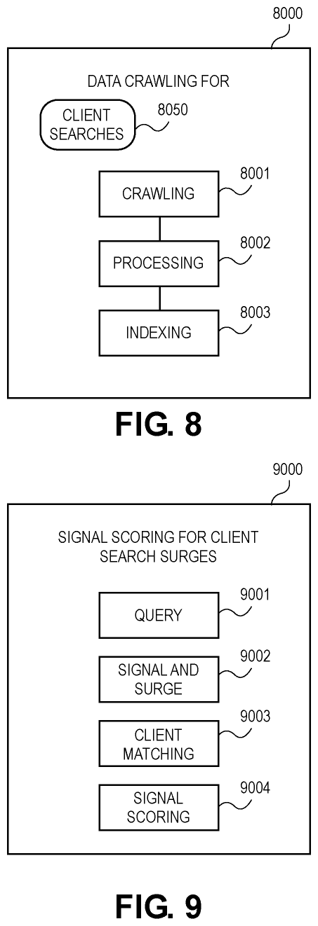

In a further aspect of the disclosure, and referring to FIG. 8, a client search crawling process 8000 is depicted. During the client search crawling process 8000, crawling is done through the searches conducted by the client, which are stored in the historical data store 6500. The client search crawling process 8000 may follow the signal scoring process 7000, but this is not a limitation of the disclosure.

Referring to FIG. 8, the client search crawling process 8000 of signal scoring for Client Searches 8050 comprises three sub steps. Client Searches 8050 are of a different nature from News 6010, Social Media 6020 and Job Postings 6030 and require different processing. There is more granularity in the client search data, such as typically two hundred million records per day, compared to one million records per day. Accordingly, additional processing power is required. The three steps depicted below attempt to extract a signal from noise.

In the Crawling Step 8001, search data files are being retrieved on a daily basis from file share locations. In the Processing Step 8002, approximately ninety percent of the search data is pruned by eliminating searches that are not associated with target companies. Eliminated searches may emanate from someone's home, or someone's mobile device for instance. Home and mobile searches may, however, be added back once it is established that such users log into company accounts on a frequent basis.

In the Indexing Step 8003, individual search records are being geo-coded using known methods and entered into the historical data store 6500.

### Signal Scoring for Client Search Surges

In a further aspect of the disclosure, and referring to FIG. 9, a client search signal scoring process 9000 is depicted. When there is a surge in searches conducted by clients, the searches are scored according to the factors depicted above in reference to FIG. 7. The client search signal scoring process 9000 may follow the client search crawling process 8000, but this is not a limitation of the inventive concept.

Referring to FIG. 9, the client search signal scoring process 9000 comprises four steps. These steps attempt to extract a signal from noise and provide scoring. While articles and posts by themselves can be individual signals, for the client search data it is the sum of hits (or matches) on keywords and the surges of the same that may define a signal.

In the Query Step 9001, keyword definitions and target companies and organizations are used to query the historical data store 6500 to find relevant search data. In the Signal and Surge Step 9002, search matches are associated with companies and locations and a trending analysis is performed over the last few months of data to determine if a surge has occurred. “Surges” are defined as quantities that are significant when compared to a baseline over a few months as determined by known methods.

In the Client Matching Step 9003, signals that have entities matching internal clients are tagged. In the Signal Scoring Step 9004, signals are matched based on the industry relative to entities as well as revenue. Signals are also geo-coded and associated with a relevant city 3015 using known geo-coding methods. In this way, a filtering step based on relevant geography can be applied. A final score is applied using the following elements, including but not limited to the following:

Determination of a surge

Internal client matching

Industry

Revenue,

relevant city 3015.

Relevant geography

### Opportunities and Risks Probability Processing

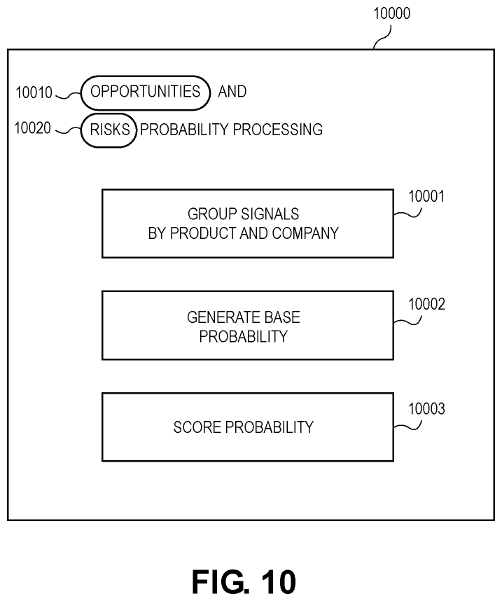

In a further aspect of the disclosure, and referring to FIG. 10, an opportunities and risks probability determination process 10000 is depicted. The opportunities and risks probability process 10000 may follow the probability determination process 9000, but this is not a limitation of the disclosure.

Referring to FIG. 10, Signals are the building blocks that are combined and analyzed to determine Opportunities and Risks. The opportunities and risks probability determination process 10000 comprises three steps. In step 10001, signals are grouped by product and company. In step 10002, base probability is generated using a plurality of factors including the following:

Signal types

Signal scores

Signal weight adjustments

Signal timing

Company industry

Company size

Location

Prior actions.

Some or all of the above factors are combined to compute a base probability for each signal, using statistics and ML models based on prior actions. The base probability, which is the probability of turning this opportunity into a deal/sale, is useful to determine what an end user should see as a priority.

In step 10003, signals are compared to one another with their attached base probabilities and a score is attached to each probability. Score Probability is calculated as:

the Sum of each Signal Score×Normalized (Company size+Company Industry+Signal Type+Location+Prior actions).

### Machine Intelligence Usage

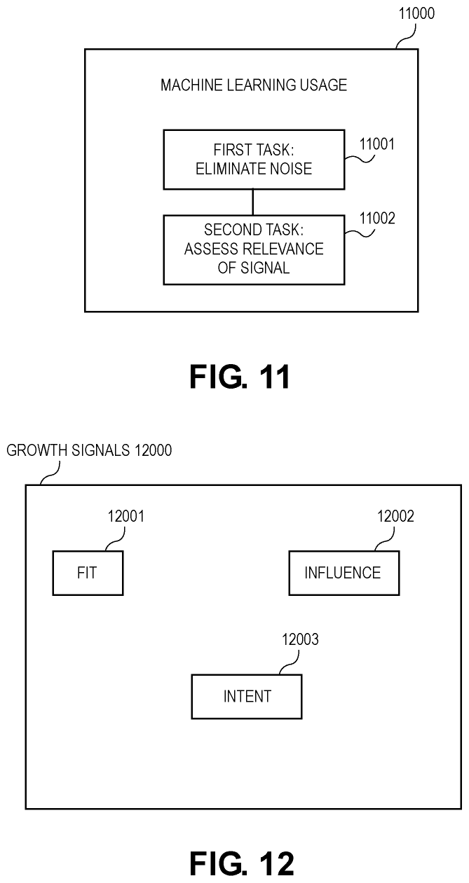

In a further aspect of the present invention, and referring to FIG. 11, a machine intelligence usage process 11000 is depicted.

Referring to FIG. 11, Machine Learning (or Machine Intelligence) is used at different stages of the process described herein. Machine Intelligence is used for two main tasks: Eliminate noise 11001 and Assess Relevance of Signal 11002.

In Eliminate Noise 11001, an assessment is made as to whether a given signal is useful information or should be considered as noise. This step is an ongoing data quality process, comprising a feedback loop. In order to obtain feedback, users and customers of the system 10 are presented with alternative potential signals and asked to vote for the ones that they consider to be relevant, and the ones that they consider to be irrelevant. This provides feedback material for a machine learning process to operate using known machine learning methods such as “XGBoost”.

In the second step 11002, feedback is received from clients on whether the signal is adapted to their focus area. More specifically, feedback of the following types is sought.

“Show me more of this”

“I am not interested in that”

In order to process such feedback, Bayesian models known in the art are used, similar to the Bayesian models that are routinely used in an electronic mail system for “spam filtering” operations.

### Growth Signals

In a further aspect of the present invention, and referring to FIG. 12, Growth Signals 12000 are depicted. Growth Signals 12000 are presented as the combination of Fit 12001, Influence 12002 and Intent 12003.

Fit 12001 corresponds to the current sales intelligence status quo in the art, and comprise such criteria including some or all of the following:

Firm information:

Sector

Size

Location

Digital Index

Cloud Technologies

Social Media presence

Supply chain

Growth Trends

Job openings

Website Profile

Search Engine Optimization Keywords

Influence 12002 comprises some or all of the following criteria:
Job Roles:
   Function
   Seniority
   Business Unit Size
   Legal Entity
   Location
Affinities
   Skills
   Experience
   Career Path
   Personality
   Culture
Affiliations
   Ownerships
   Partnerships
   School Alumni
   Board
   Memberships
Markets
   Competitor Event
   Industry Event

Intent 12003 comprises some or all of the following criteria:

Topic Surge:
Internet Search
Internet Browsing
Corporate Events
Corporate Social Media
Sales Emails
Marketing Campaigns

Usage Surge:

Product Shipments

Service Usage

Payments

Interaction Volume

Transaction Volume

### Identification of Potential Buyers

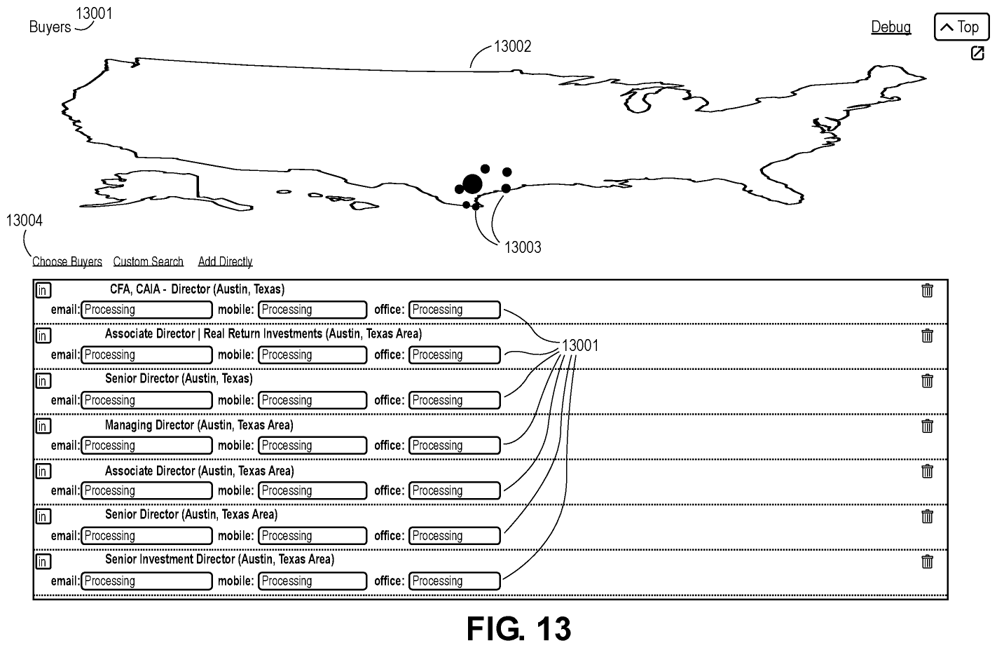

In a further aspect of the disclosure, and referring to FIG. 13, potential buyers may be identified by the system 10. Referring to FIG. 13, an example illustration of a User Interface shows the potential Buyers report 13001. A map 13002 of relevant territory is also displayed with the location 13003 associated with each Buyer 13001. Users typically provide information pertaining to a target market, preferably including company sector and size, as well as information on products and services sold.

Further referring to FIG. 13, Buyers may be displayed on a Buyers List 13004. Each buyer 13001 on the list may be associated with one or more of the following: phone number, email, title, address, Social Media channel. Such buyer information and channel of potential contact should be regarded in an illustrative rather than a restrictive sense.

Such information may be obtained by querying the Store 6500, finding names and titles of officers in certain signals related to news and job postings, and accessing databases such as LinkedIn.

While the embodiments are described in terms of a method or technique, it should be understood that the disclosure may also cover an article of manufacture that includes a non-transitory computer readable medium on which computer-readable instructions for carrying out embodiments of the method are stored. The computer readable medium may include, for example, semiconductor, magnetic, opto-magnetic, optical, or other forms of computer readable medium for storing computer readable code. Further, the disclosure may also cover apparatuses for practicing embodiments of the inventive concept disclosed herein. Such apparatus may include circuits, dedicated and/or programmable, to carry out operations pertaining to embodiments. Examples of such apparatus include a general-purpose computer and/or a dedicated computing device when appropriately programmed and may include a combination of a computer/computing device and dedicated/programmable hardware circuits (such as electrical, mechanical, and/or optical circuits) adapted for the various operations pertaining to the embodiments.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A computer-implemented method for identifying an opportunity, comprising:
monitoring electronic activity and searches for events,
receiving user criteria via a user interface,
ranking the events using the user criteria,
generating signals from said events,
extracting one or more opportunities from the signals and determining an action that is likely to turn at least one opportunity of the opportunities into sales.

2. The computer-implemented method of claim 1, wherein the generating of signals further comprises:
removing irrelevant text and tags, and removing duplicates from events;
using natural language processing to extract organization names, people names and locations from the text, and
categorizing opinions in the text, and determining if the text is positive, negative or neutral toward a topic.

3. The computer-implemented tracking method of claim 2, further ranking the centrality and importance of an entity in a data source.

4. The computer-implemented tracking method of claim 1, wherein the user criteria comprise a target market and products and services that are sold.

5. The computer-implemented tracking method of claim 4, wherein the target market further comprises data on company sector and size.

6. The computer-implemented method of claim 1, wherein the events are extracted from one of the following data sources:
news, social media and job postings, and
client searches.

7. The computer-implemented tracking method of claim 1, wherein the generating of signals from the events comprises:
matching entities with clients,
matching signals relative to entities and revenue,
geo-coding signals and associating signals to a relevant geography, and
determining a score using one or more of:
a base score,
A time window,
Entity,
Revenue,
Relevant geography.

8. The computer-implemented tracking method of claim 1, wherein generating the signals from the events comprises:
determining whether a surge of searches has occurred,
matching entities with clients
matching signals relative to entities and revenue
geo-coding signals and associating signals to a relevant geography
determining a score using one or more of:
a base score,
entity,
revenue,
relevant geography.

9. The computer-implemented method of claim 1, further comprising determining opportunities and risks by:
grouping signals by product and company,
generating a base probability,
comparing signals to one another and attaching a score to each base probability.

10. The computer-implemented method of claim 9, wherein the base probability is generated by factoring one or more of the following:
Signal types,
Signal scores,
Signal weight adjustments,
Signal timing,
Company industry,
Company size,
Location,
Prior actions.

11. The computer-implemented method of claim 1, further comprising characterizing the opportunity as one of the following based on the events:
An early opportunity,
An active opportunity,
A definite opportunity,
A missed opportunity.

12. The computer-implemented method of claim 1, further associating a window of opportunity to the opportunity, wherein the window of opportunity represents a time period during which the action, if taken, has maximum likelihood of turning the opportunity into sales.

13. The computer-implemented method of claim 1, further associating an opportunity map with an opportunity, wherein the opportunity map displays the geographical locations from where the events originate, and wherein a surface area associated with a signal indicates the importance of the signal.

14. The computer-implemented method of claim 1, further associating a chart with an opportunity, wherein the chart displays data sources associated with the opportunity, and wherein a larger surface area on the chart indicates that more signals originated from the data source represented by that larger surface area.

15. The computer-implemented method of claim 1, further defining an opportunity by assessing the impact of signals and grouping signals by product and company.

16. The computer-implemented method of claim 1, the action includes contacting a predetermined buyer.

17. The computer-implemented method of claim 1, wherein the user criteria include data pertaining to a target market, and products and services sold.

18. The computer-implemented method of claim 17, wherein the user criteria include contact names of buyers.

19. The computer-implemented method of claim 18, wherein the buyers are displayed in at least one of a list and a map.

20. The computer-implemented method of claim 18, further comprising obtaining one or more of the following for the buyers:
Name,
Title,
Phone number,
Email,
Social Media channel,
Address.
